(19) United States
(12) Patent Application Publication
(10) Pub. No.: US 2023/0381896 A1
(43) Pub. Date: Nov. 30, 2023

(54) METHOD FOR IDENTIFYING A DISRUPTION DURING A MACHINING PROCESS, AND MACHINING APPARATUS

(71) Applicant: TRUMPF WERKZEUGMASCHINEN SE + Co. KG, Ditzingen (DE)

(72) Inventors: Winfried Magg, Ditzingen (DE); Boris Regaard, Stuttgart (DE); David Schindhelm, Stuttgart (DE); Steffen Kessler, Stuttgart (DE)

(21) Appl. No.: 18/447,339

(22) Filed: Aug. 10, 2023

Related U.S. Application Data
(63) Continuation of application No. PCT/EP2022/051898, filed on Jan. 27, 2022.

(30) Foreign Application Priority Data
Mar. 11, 2021 (DE) 10 2021 202 350.9

(51) Int. Cl. B23K 31/12; B23K 26/38

(52) U.S. Cl. CPC B23K 31/125; B23K 26/38

(57) ABSTRACT

A method for identifying disruptions during a machining process, more particularly during a cutting process, includes: machining, more particularly cutting, a workpiece while moving a machining tool, in particular a laser machining head, and the workpiece relative to one another, recording an image of a region on the workpiece to be monitored, the region to be monitored being an interaction region of the machining tool with the workpiece, and evaluating the image of the region to be monitored. For the purpose of identifying at least one disruption of the machining process, the presence or the lack of a local intensity drop in an intensity profile within the interaction region is detected, during the evaluation of the image, in an advancement direction of the machining process. There is also described an associated machining apparatus.

### CROSS-REFERENCE TO RELATED APPLICATION

This application is a continuation, under 35 U.S.C. § 120, of copending International Patent Application PCT/EP2022/051898, filed Jan. 27, 2022, which designated the United States; this application also claims the priority, under 35 U.S.C. § 119, of German Patent Application DE 10 2021 202 350.9, filed Mar. 11, 2021; the prior applications are herewith incorporated by reference in their entirety.

### FIELD AND BACKGROUND OF THE INVENTION

The present invention relates to a method for identifying at least one disruption or fault during a machining process, more particularly during a cutting process, comprising: machining, more particularly cutting, a workpiece while moving a machining tool, in particular a laser machining head, and the workpiece relative to one another, recording an image of a region on the workpiece to be monitored, said region to be monitored comprising an interaction region of the machining tool with the workpiece, and evaluating the image of the region to be monitored, for the purpose of identifying the at least one disruption of the machining process. The invention also relates to a machining apparatus comprising: a machining tool, in particular a laser machining head, for machining, more particularly cutting, a workpiece, a movement device for moving the machining tool and the workpiece relative to one another, an image capturing device for recording an image of a region on the workpiece to be monitored, said region to be monitored comprising an interaction region of the machining tool, more particularly of the laser machining head, with the workpiece, and an evaluation device configured to identify at least one disruption of the machining process on the basis of the evaluation of the image of the region to be monitored.

A disruption in the form of an incomplete cutting action may arise as a disruption within the scope of a machining process in the form of a cutting process using a machining beam, for example a plasma or laser beam, in the case of, for example, an extensively machining machining apparatus in the form of a 2-D laser cutting apparatus. In the case of an incomplete cutting action, the machining beam no longer cuts through the entire (metallic) workpiece since the path energy is not sufficient to fuse the entire cutting gap volume.

German patent DE 10 2013 209 526 B4 and its counterpart U.S. Pat. No. 9,457,427 B2 proposes to record an image of a region of the workpiece to be monitored, comprising an interaction region between a high-energy beam and the workpiece, for the purpose of identifying an incomplete cutting action when cutting with said high-energy beam, in particular a laser beam. The image is evaluated for the detection of slag droplets at an end of the interaction region opposite a cutting front and the incomplete cutting action is identified on the basis of the occurrence of slag droplets. The slag droplets can be detected on the basis of a change in the geometry of the interaction region at its end opposite to the cutting front and/or on the basis of the occurrence of a local intensity minimum in the image of the end of the interaction region opposite to the cutting front.

International publication WO 2016/181359 A1 describes that a detector in the form of a photodiode can be used to detect a brief incomplete cutting action, said photodiode being designed in trailing fashion, which is to say viewing backwardly into the cutting gap, and the observation direction thereof being oriented at a polar angle of greater than 5° in relation to the optical axis of a work laser beam. Said publication also describes that pseudo-defects may occur when an incomplete cutting action is identified, because other effects, for example an increased cutting speed or a wider cutting gap, may be overlaid, with a similar order of magnitude, on an effect caused by an incomplete cutting action.

German published patent application DE 10 2018 217 526 A1 and its counterpart published patent application US 2021/0229220 A1 discloses a method in which at least one characteristic for the process quality of the machining process is determined on the basis of a monitored region on the workpiece, which may comprise an interaction region between a machining region and the workpiece. In the method, at least one position-dependent characteristic for the process quality is determined on the basis of a plurality of measured values of the at least one characteristic at the same machining position and/or at least one direction-dependent characteristic for the process quality is determined on the basis of a plurality of measured values of the at least one characteristic in the same machining direction.

With the aid of the method described therein, it is possible to identify disruption position regions which depend on the machining position or the position in the work space but substantially do not depend on the geometry of the contour to be cut, the type of machining process (e.g., flame cutting or fusion cutting) and the machining parameters. Specified examples of position-dependent disruptions include, inter alia, supporting bars which are arranged in the work space and which may impair the machining process, and hence the cutting result, when contaminated by slag. Disruptions in the form of miscuts, incomplete cutting actions, slag adherence, formation of burrs and spatter, and burnouts of the cutting edges are only a few examples of an impairment of the cutting process by contaminated supporting bars.

German published patent application DE 10 2017 210 182 A1 discloses a method in which the actual state of a transverse extent of a support slat is captured by means of capturing equipment. By way of example, the actual state of the support slat can be captured by applying an optical method, which is to say a method from optical metrology and/or an imaging method. In the former case, the support slat can be arranged between an optical emitter and an optical sensor of the capturing equipment, and the transverse extent of the support slat can be imaged onto the optical sensor by means of an optical beam. In the latter case, the support slat and a camera of the capturing equipment may be located opposite one another and an image of the transverse extent of the support slat is recorded by means of the camera.

A method in which an actual value of a support slat contour is captured by means of an optical sensor in order to monitor a workpiece support for the presence of deposits to be removed is described in European published patent application EP 2 082 813 A1.

### SUMMARY OF THE INVENTION

The invention is based on the object of providing a method and a machining apparatus for reliably identifying disruptions during a machining process.

With the above and other objects in view there is provided, in accordance with the invention, a method for identifying at least one disruption during a machining process, the method comprising:
machining a workpiece while moving a machining tool and the workpiece relative to one another;
recording an image of a region on the workpiece to be monitored, the region to be monitored being an interaction region of the machining tool with the workpiece;
evaluating the image of the region to be monitored for identifying the at least one disruption during the machining process by detecting a presence or a lack of a local intensity drop in an intensity profile within the interaction region along an advancement direction of the machining process.

In a preferred embodiment of the invention, the machining process is a cutting process, the machining step is a cutting step, and the machining tool is a laser machining head.

In other words, the objects of the invention are achieved by a method in which, for the purpose of identifying the disruption, the presence or the lack of a local intensity drop in an intensity profile within the interaction region is detected, during the evaluation of the image, in an advancement direction of the machining process.

During the machining process, for example during the laser cutting, an image of the interaction region (process emission zone or process light) is captured in real time (e.g., at a frequency of more than 400 Hz) by means of an imaging sensor system or image capturing device and evaluated in real time with the aid of suitable image processing algorithms, in order to extract or analyze features of the interaction region which allow the identification of disruptions during the machining process.

A plausibility check allowing process-reliable identification of the presence of a disruption or the type of disruption is essential during the identification of disruptions on the basis of features which are extracted within the scope of the evaluation of the image of the interaction region. It was found that it is not possible to make an unambiguous distinction between a real incomplete cutting action and a pseudo-incomplete cutting action purely on the basis of geometric features of the interaction region, for example on the basis of the length of the interaction region, when identifying a disruption of the machining process in the form of an incomplete cutting action. Such a pseudo-incomplete cutting action may occur if other disruptions, which for example are caused by supporting bars of a workpiece mount or by the type of workpiece (e.g., a double metal sheet) and which change the geometric features of the interaction region in the same way as in the case of an incomplete cutting action, occur during the cutting process.

In these cases, which is to say in the case of a “disrupted” cutting process, there generally cannot be a process-reliable identification of an incomplete cutting action purely on the basis of geometric features of the interaction region, which is to say an incomplete cutting action may be identified even though an incomplete cutting action did not occur during the cutting process. However, the intensity profile of the interaction region in the advancement or cutting direction, which is to say in the direction of the instantaneous relative movement between the workpiece and the machining tool, can be used to make a distinction as to whether or not an incomplete cutting action is present. However, a further geometric feature of the interaction region is generally additionally required to identify the incomplete cutting action, as described in detail hereinbelow.

The local intensity drop in the intensity profile usually occurs in the region of the actually expected (nominal) end of the cutting front or interaction region in the case of a non-disrupted cutting process. However, if an incomplete cutting action is present, the length of the interaction region in the advancement direction is extended, with the result that the local intensity drop occurs not at the end of the interaction region but within the interaction region, which is to say the intensity in the advancement direction is increased vis-à-vis the local intensity minimum both before and after the intensity drop or a local intensity minimum.

By way of example, the presence of a local intensity drop can be detected if the intensity profile within the interaction region has a local minimum, the intensity value of which is below a specified percentage component, for example less than 80%, of a maximum intensity value within the interaction region. The intensity value of the intensity profile increases upstream and downstream of the local intensity minimum in the advancement direction, until the intensity profile drops sharply at the front and back end of the interaction region. The percentage component of the maximum intensity value at which a local intensity drop is detected is not necessarily determined in advance but may optionally be defined on the basis of the current work point.

Alternative or additional further criteria may optionally be used for the detection of the presence or lack of a local intensity drop. By way of example, the presence or lack of the local intensity drop may be detected on the basis of a gradient of the intensity profile, which is to say on the basis of the derivative of the intensity profile in the advancement direction. The gradient of the intensity profile has a zero crossing, where the gradient increases from negative values to positive values, at a local minimum of the intensity profile within the interaction region. The zero crossing of the gradient is located between a local minimum and a local maximum of the gradient. It is likewise possible to detect the local intensity drop on the basis of the profile of the gradient, for example on the basis of the absolute value of the local minimum or local maximum, which represents a measure of the steepness of the local intensity drop. By way of example, the absolute value of the gradient at the location of the local minimum or local maximum or the increase of the gradient from the local minimum to the local maximum can be used and compared to a threshold value to this end.

In a variant, an incomplete cutting action is only identified as a disruption during the cutting of the workpiece in the case where the lack of the local intensity drop is detected within the interaction region. What is exploited here is that the intensity profile in the cutting direction does not have a local intensity drop (“discontinuity”) and hence also no local intensity minimum, or only a local intensity minimum that deviates slightly from a maximum intensity value, in the case of a real incomplete cutting action, whereas this typically is the case for a disruption in the form of a supporting bar or in the presence of a double metal sheet since such a “disruption” in the material flow generates a lower process emission at a respective point of the interaction region. Therefore, a distinction between a real incomplete cutting action and a pseudo-incomplete cutting action can be made on the basis of the intensity profile within the interaction region.

For the purpose of identifying the disruption, at least one geometric feature of the interaction region, in particular a length of the interaction region in the advancement direction, is detected or determined by image analysis during the evaluation of the image in a variant. As described hereinabove, geometric features of the interaction region can be used to identify disruptions during the machining process, in particular a disruption in the form of an incomplete cutting action. In this case, the geometric features may be combined with other features of the interaction region, for example with the intensity or the intensity profile in the interaction region or in a process light region of interest (see below), in order to identify the respective disruption.

In a development of this variant, an incomplete cutting action is identified during the cutting if a characteristic that depends on the length of the interaction region exceeds a threshold value and if the lack of the local intensity drop is detected within the interaction region.

The characteristic which depends on the length of the interaction region is a function which is dependent on the length of the interaction region. In the simplest case, the characteristic is the length of the interaction region itself. It is also possible for the characteristic to be a variable proportional to the length of interaction region, which is to say the length of the interaction region is multiplied by a weighting factor. However, it is also possible for there to be a more complicated relationship between the characteristic and the length of the interaction region. In addition to the length of the interaction region, other parameters of the recorded image may be included in the characteristic, for example a (mean) intensity of the recorded image or of a partial region of the recorded image, the width of the interaction region, etc.

The threshold value can be an absolute value; however, the threshold value may also be a percentage change of a current/defined work point of the characteristic. In this case, the characteristic determined on the basis of the image is related to a currently specified characteristic. To this end, it is for example possible to form a quotient of the characteristic determined on the basis of the image to the characteristic at the work point. In this case, the quotient is compared to the threshold value.

In this case, two criteria have to be satisfied in order to identify an incomplete cutting action: Firstly, the characteristic must exceed a specified threshold value (incomplete cutting action threshold), and, secondly, the criterion whereby no local intensity drop in the intensity profile occurs within the interaction region must be satisfied. An incomplete cutting action is present in the case where both criteria are fulfilled over a given (short) path length, for example of the order of approx. 10 mm, in the respectively recorded images of the interaction region. In this case, the machining process may be interfered with, for example an advancement halt may be triggered, or an information item/warning/error message may be generated and output.

To calculate the characteristic, the exact manifestation of the length of the interaction region, which is to say of the process zone of the process light, is determined. Subsequently, the size of the process light region of interest is defined with the aid of data from the process zone or region to be monitored. Typically, the manifestation of the process light region of interest ranges as far as the nozzle edge—when the image is recorded through a machining nozzle—in the advancement direction and extends over the entire width of the interaction region transversely to the advancement direction. By way of example, the length of the interaction region is determined by comparing the intensity to an intensity threshold or by evaluating the intensity gradient. By way of example, the intensity threshold value during the length measurement can be calculated in the form of a quotient of the mean intensity of the process light region of interest (see above) and a weighting factor.

As a rule, the manifestation of the cutting front or interaction region (process emission) visible to the image capturing device, for example in the form of a camera, is detectable up to the lower side of the workpiece. A change (lengthening) of the interaction region is caused by disruptions to the cutting process, such as advancement, focal position, gas pressure, contamination of the optics, supporting bars, a workpiece in the form of a double metal sheet, etc. During real cutting operation, it is mainly supporting bars and less frequently double metal sheets that are the cause of a substantial change in the cutting front or interaction region, in particular in the length thereof in the advancement direction.

As described hereinabove, the change of the characteristic if these disruptions occur is of the order of the change in the case of a real incomplete cutting action. Therefore, it is not possible to distinguish between a real incomplete cutting action and a pseudo-incomplete cutting action using only the characteristic. Only a plausibility check on the basis of verifying whether or not a local intensity drop occurs in the intensity profile and a temporal or path length-dependent observation render it possible to reliably identify an incomplete cutting action. An incomplete cutting action is typically only identified once both criteria have been satisfied over a given path length.

In a further variant, the detection, in particular the repeated detection, of the local intensity drop at a machining position is assigned to a position-dependent disruption of the machining process, in particular the presence of a supporting bar, at the machining position. As described hereinabove, contaminated supporting bars in particular may represent a position-dependent disruption which impairs the machining process, specifically the cutting process. If the machining positions of the supporting bars or of other position-dependent disruptions are known, then these may be taken into account accordingly for the machining process, for example for the parts or contours to be cut.

To find the machining positions at which position-dependent disruptions occur, for example as a result of supporting bars, the occurrence of a disruption in the form of a local intensity drop in the intensity profile of the interaction region is assigned to a current machining position in apparatus coordinates (X/Y/Z). On the basis of these coordinates, it is possible to exactly determine and optionally classify position-dependent disruptions, such as supporting bars or hot spots at individual positions of the supporting bars, in the work space of the machining apparatus, as described hereinafter.

In a development, a degree of the position-dependent disruption, in particular a degree of (local) contamination of the supporting bar, is determined on the basis of the intensity profile, in particular on the basis of a gradient of the intensity profile. The manifestation, which is to say the size, of the position-dependent disruption can be deduced on the basis of the gradient of the intensity profile in the region of the local intensity drop. By way of example, a degree of contamination of a supporting bar can be determined on the basis of the absolute value of a local minimum or local maximum of the gradient of the intensity profile in the region of the local intensity drop. In principle, what holds true is that a smaller local minimum or local maximum of the gradient in terms of absolute value can be assigned to a greater degree of contamination of the supporting bar, and vice versa. Alternatively, or in addition, the degree of the position-dependent disruption can also be determined on the basis of the size of the local intensity drop in the intensity profile of the recorded image. In principle, what holds true is that a greater intensity drop in terms of absolute value may be assigned to a smaller (local) degree of contamination of the supporting bar at the machining position, and vice versa.

The degree of contamination of the supporting bar influences the degree of disruption of the machining process: A “new” supporting bar with only small amounts of slag or contamination at a specific machining position has only a small influence on the cutting process, while an “old”, very contaminated supporting bar may have a critical influence on the machining process at a specific machining position.

The size or the degree of the position-dependent disruption can be used to adapt the machining process, for example a cutting process, more precisely the cutting program of the cutting process, in order to accordingly take account of the position-dependent disruption variable or the degree of disruption, or in order to carry out changes in the procedure or in the control within the scope of the machining process. By way of example, depending on the degree of the position-dependent disruption(s), it is possible to implement (re-)nesting of the workpiece parts to be cut on the workpiece, an adaptation of the application planning, an optional replacement of very contaminated supporting bars, etc. It is self-evident that the information relating to the degree of disruption or the degree of contamination may also be appropriately formulated and/or displayed to the user.

The type of disruption can also be classified on the basis of further features of the interaction zone, for example on the basis of the width and/or length thereof. The manifestation, which is to say the size or degree of the disruption, can also be determined. To this end, the local manifestation and profile of the disruption can be captured during the cutting process and/or over the history thereof, for example by cutting over or traversing one and the same machine position multiple times. In addition or as an alternative to the position-dependent disruptions, disruptions that depend on the machining direction can also be identified by evaluating the image of the interaction region or a temporal sequence of images, and the type or manifestation of said disruptions can be determined as described in the above-mentioned German published patent application DE 10 2018 217 526 A1 and its counterpart published patent application US 2021/0229220 A1, for example, the entirety of which is incorporated herein by reference.

In a further variant, the type of disruption of the machining process is deduced on the basis of the evaluation of a plurality of temporally successive images of the interaction region. As described hereinabove, the trajectory during machining, and consequently the current machining position, is known relative to the work space. This allows the recorded images to be assigned to the machining positions or work space.

The supporting bars are typically arranged in the work space at specified coordinates in a first direction (e.g., X-direction) and extend in a second direction (Y-direction). Consequently, there is a recurrent or—in the case of extreme amounts of slag on the bars—optionally constant disruption in the Y-direction at certain positions in the X-direction. By contrast, the disruptions are locally restricted in the X-direction as a rule, to be precise to the extent of the supporting bar in the X-direction. By evaluating a plurality of successive images, it is therefore possible to deduce a position-dependent disruption of the machining process in the form of a supporting bar.

The position-dependent and direction-dependent disruptions in the work space characteristic for a double metal sheet can also be determined on the basis of a plurality of images of the interaction region which are assigned to a respective machining position and machining direction during the movement along the trajectory. By way of example, a disruption in the form of a double metal sheet can be deduced in this way.

With the above and other objects in view there is also provided, in accordance with the invention, a machining apparatus of the type set forth at the outset, in which for the purpose of identifying the disruption, the evaluation device is configured to detect, during the evaluation of the image, the presence or the lack of a local intensity drop in an intensity profile within the interaction region in an advancement direction of the machining process. If a supporting bar or double metal sheet is momentarily traversed during the machining process, then there is a local intensity drop in the intensity profile which is otherwise substantially constant within the interaction region.

By way of example, a local intensity drop can be detected if the intensity profile within the interaction region has a local minimum, the intensity value of which is below a specified percentage component, for example less than 80%, of a maximum intensity value within the interaction region. The intensity value of the intensity profile increases upstream and downstream of the local intensity minimum in the advancement direction, until the intensity profile drops sharply at the front and back end of the interaction region.

Alternatively, or in addition, the presence or the lack of a local intensity drop can also be detected on the basis of the gradient of the intensity profile. As described hereinabove, the absolute value of the gradient at the location of a local minimum or local maximum within the interaction region or the increase of the gradient from the local minimum to the local maximum, for example, can be used and compared to a threshold value to this end.

In an embodiment, the evaluation device is configured to identify an incomplete cutting action only as a disruption during the cutting of the workpiece in the case where the lack of the local intensity drop is detected within the interaction region. If no local intensity drop is present, then it is typically the case that no supporting bar is traversed or there is no double metal sheet, which is to say that the cutting process is not influenced by these disruption variables. In this case, the presence of an incomplete cutting action can be deduced purely on the basis of a geometric criterion or on the basis of geometric features of the interaction region.

For the purpose of identifying the disruption, the evaluation unit in a further embodiment is configured to detect, during the evaluation of the image, at least one geometric feature of the interaction region, in particular a length of the interaction region in the advancement direction. As described hereinabove, the type of disruption can be identified inter alia on the basis of geometric features of the interaction region, which is to say the disruption can be classified. By way of example, the length of the interaction region in the advancement direction can be used to identify that there is no incomplete cutting action if a given incomplete cutting action criterion has not been satisfied.

In a development, the evaluation unit is configured to identify an incomplete cutting action during the cutting if a characteristic that depends on the length of the interaction region exceeds a threshold value and if the lack of the local intensity drop is detected within the interaction region. Both criteria need to be satisfied for the process-reliable identification of an incomplete cutting action, which is to say, firstly, the characteristic must exceed a given threshold value and secondly, no local intensity drop may be detected within the interaction region.

In a further embodiment, the evaluation device is configured to assign the detection, in particular the repeated detection, of the local intensity drop at a machining position to a position-dependent disruption of the machining process, in particular the presence of a supporting bar, at the machining position. Should a local intensity drop occur at least twice or more than two times at one and the same machining position—when different workpieces are machined—then it is very probable that a supporting bar is present at this machining position, which is to say a disruption in the form of a double metal sheet can be virtually excluded. In this way, a disruption in the form of a very contaminated supporting bar can be processed-reliably distinguished from a disruption in the form of a double metal sheet.

In a further embodiment, the evaluation device is configured to determine a degree of the position-dependent disruption, in particular a degree of contamination of the supporting bar, on the basis of the intensity profile, in particular on the basis of a gradient of the intensity profile. As described hereinabove, a very contaminated supporting bar or a double metal sheet is present in the case of a comparatively small absolute value of the local minimum or local maximum of the gradient in the region of the position-dependent disruption. If the absolute value of the local minimum or local maximum of the gradient is comparatively large, then this indicates the presence of a virtually uncontaminated supporting bar, which has only little influence on the cutting process. It is understood that the gradient of the intensity profile can also be evaluated differently in order to deduce the degree of the position-dependent disruption. The intensity profile itself can also be evaluated for this purpose, for example by virtue of the absolute value of the local intensity drop, which is to say the difference between the maximum intensity value in the interaction region and the intensity value of the local intensity minimum, being determined.

In a further embodiment, the evaluation device is configured to deduce the type of disruption of the machining process on the basis of the evaluation of a plurality of temporally successive images of the interaction region. As described hereinabove, supporting bars or the presence of a double metal sheet, for example, may be identified, or distinguished from one another, as types of disruptions.

Further advantages of the invention are evident from the description and the drawing. Likewise, the features mentioned above and those that are yet to be presented can be used in each case by themselves or as a plurality in any desired combinations. The embodiments shown and described should not be understood as an exhaustive list, but rather are of an exemplary character for outlining the invention.

Other features which are considered as characteristic for the invention are set forth in the appended claims.

Although the invention is illustrated and described herein as embodied in a method for identifying a disruption during a machining process, and machining apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 shows a schematic illustration of a laser machining apparatus for carrying out a laser cutting process;

FIG. 2 shows a schematic illustration of equipment for monitoring the laser cutting process by recording an image of a region of the workpiece to be monitored, said region containing an interaction region;

FIGS. 3A-3C show schematic illustrations of images of the interaction region and of an intensity profile along the interaction region in the case of a non-disrupted cutting process, an incomplete cutting action, and a traversal of a supporting bar; and

FIGS. 4A and 4B show schematic illustrations analogous to FIGS. 3A-3C when traversing a very contaminated supporting bar and an almost new supporting bar, respectively.

### DETAILED DESCRIPTION OF THE INVENTION

In the following description of the drawings, identical reference signs are used for identical or functionally identical components.

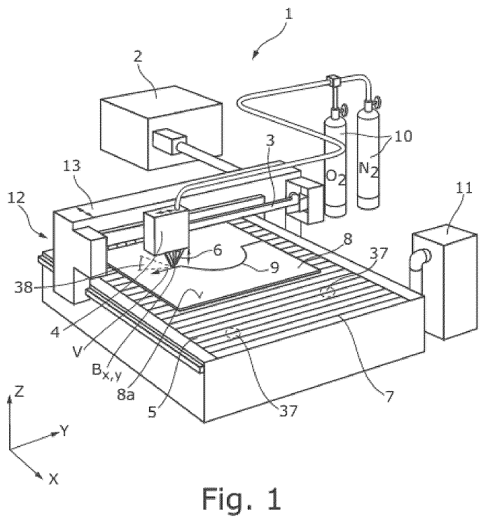

FIG. 1 shows a machining apparatus in the form of a laser machining apparatus 1 with a laser source 2, a laser machining head 4, and a workpiece support 5. A laser beam 6 generated by the laser source 2 is guided by means of a beam guide 3 with the aid of deflecting mirrors (not shown) to the laser machining head 4 and focused therein and also aligned perpendicular to the surface 8a of a workpiece 8 with the aid of mirrors that are likewise not depicted, which is to say the beam axis (optical axis) of the laser beam 6 is perpendicular to the workpiece 8. In the example shown, the laser source 2 is a CO₂ laser source. Alternatively, the laser beam 6 can be generated by way of a solid-state laser, for example.

For laser cutting the workpiece 8, first the laser beam 6 is used for piercing, which is to say the workpiece 8 is melted or oxidized at a location in the form of a point and the melt thereby produced is blown out. After that, the laser beam 6 is moved over the workpiece 8, so as to form a continuous kerf 9, along which the laser beam 6 cuts through the workpiece 8.

Both the piercing and the laser cutting can be assisted by adding a gas. Oxygen, nitrogen, compressed air and/or application-specific gases may be used as cutting gases 10. Arising particles and gases may be suctioned from a suction chamber (not depicted here) located below the workpiece support 5 with the aid of a suction device 11.

The laser machining apparatus 1 also comprises a movement device 12 for moving the laser machining head 4 and the workpiece 8 relative to one another. In the example shown, the workpiece 8 rests on the workpiece support 5 during the machining, and the laser machining head 4 is moved along two axes X, Y of an XYZ-coordinate system during the machining. To this end, the movement device 12 comprises a gantry 13 which is displaceable in the X-direction with the aid of a drive indicated by a double-headed arrow. The laser machining head 4 can be displaced in the X-direction with the aid of a further drive, indicated by a double-headed arrow, of the movement device 12, in order to be moved to any desired machining position B_{X,Y} in the X-direction and Y-direction in a work field which is specified by the displaceability of the laser machining head 4 or by the workpiece 8. At a respective machining position B_{X,Y}, the laser beam 6 has an (instantaneous) advancement direction V, which corresponds to the (instantaneous) relative velocity between the laser machining head 4 and the workpiece 8.

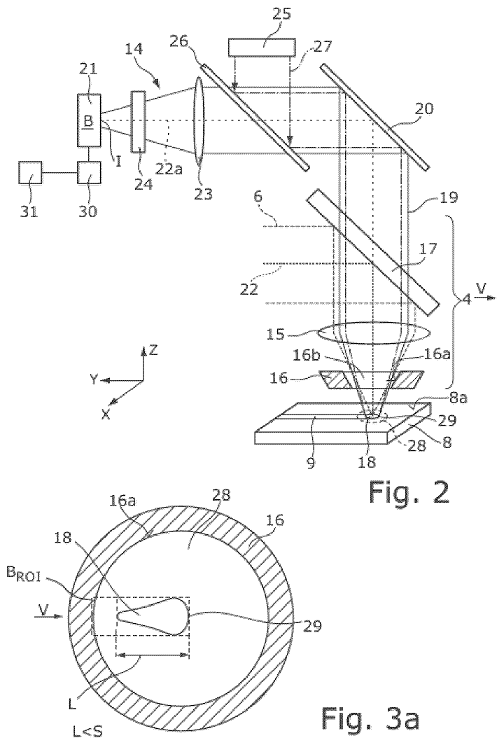

FIG. 2 shows an exemplary structure of equipment 14 for process monitoring and process control of a laser cutting process on the workpiece 8 by means of the laser machining apparatus 1 of FIG. 1, of which only the laser machining head 4 with a focusing lens 15 made of zinc selenide for focusing the laser beam 6 of the laser machining apparatus 1, a cutting gas nozzle 16, and a deflecting mirror 17 have been depicted very schematically. In the present case, the deflecting mirror 17 has a partially transmissive design and forms an entrance-side component for the process monitoring equipment 14.

The deflecting mirror 17 reflects the incident laser beam 6 (at a wavelength of approx. 10 μm) and transmits process monitoring-relevant radiation 19 which is reflected by the workpiece 2 and emitted by an interaction region 18 of the laser beam 5 with the workpiece 2 and which has a wavelength range between approx. 550 nm and 2000 nm in the present example. As an alternative to the partly transmissive deflecting mirror 17, a scraper mirror or a hole mirror can also be used to feed the process radiation 19 to the equipment 14.

A further deflecting mirror 20 is arranged downstream of the partly transmissive mirror 17 in the equipment 14 and deflects the process radiation 19 to a geometrically highly resolving camera 21 as an image capturing unit. The camera 21 can be a high-speed camera which is arranged coaxially with the laser beam axis 22 or the extension of the laser beam axis 22a and consequently arranged directionally independently. In principle, it is also possible to record the image with the camera 21 using the reflected-light method in the VIS wavelength range, optionally also in the NIR wavelength range, provided an additional illumination source emitting in this wavelength range is provided, and alternatively it is also possible to record the process self-luminescence in the wavelength ranges of UV and NIR/IR.

For imaging purposes, an imaging, focusing optical system 23, which is depicted as a lens in FIG. 2, is provided between the partly transmissive mirror 17 and the camera 21 in the present example, said optical system focusing the radiation 19 relevant to process monitoring onto the camera 21. In the example shown in FIG. 2, a filter 24 in front of the camera 21 is advantageous if further radiation or wavelength components should be prevented from being captured by the camera 21. The filter 24 can be in the form of a narrow bandwidth band pass filter, for example.

In the present example, the camera 21 is operated using the reflected light method, which is to say an additional illumination source 25 is provided above the workpiece 8 and input couples illumination radiation 27 into the beam path coaxially with the laser beam axis 24 by way of a further partly transmissive mirror 26. Laser diodes or diode lasers can be provided as an additional illumination source 25 and can be arranged coaxially, as shown in FIG. 2, or else off-axis in relation to the laser beam axis 22. By way of example, the additional illumination source 25 may also be arranged outside of (in particular next to) the laser machining head 4 and may be directed at the workpiece 8; alternatively, the illumination source 25 may be arranged within the laser machining head 4 but not be directed at the workpiece 8 coaxially with the laser beam 6. It is understood that the equipment 14 may also be operated without an additional illumination source 25.

During a laser flame cutting process, the camera 21 records an image B of a region 28 of the workpiece 8 to be monitored, which contains interaction region 18, in the example illustrated in FIG. 2. During the cutting process there is a relative movement between the workpiece 8 and the laser machining head 4 as a result of the movement of the laser machining head 4 in the positive Y-direction (cf. arrow) at the relative speed denoted as the advancement speed V. During the cutting process, a cutting front 29 is formed in the leading region of the interaction region 18 and is adjoined in the trailing region (in the negative Y-direction) by the kerf 9.

The image capturing device 21 in the form of the camera is signal-connected to an evaluation device 30. The evaluation device 30 is configured or programmed to identify at least one disruption to the machining process, for example an incomplete cutting action, on the basis of the evaluation of the recorded image B or a temporal sequence of images B of the region 28 to be monitored.

To this end, the evaluation device 30 evaluates the image B or a sequence of successively recorded images B of the interaction region 18 in order to extract or identify features of the interaction region 18 which indicate a disruption to the cutting process.

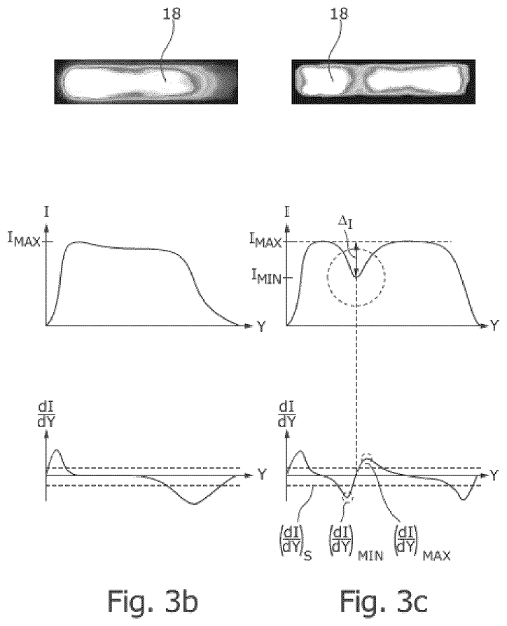

FIG. 3A shows an example of the image B of an interaction region 18 in the case of a good cut, which is to say a non-disrupted cutting process. As is evident from FIG. 3A, the interaction region 18 has a comparatively short length L in the advancement direction V and, in the example shown, corresponds to about twice the width of the interaction region 18 transversely to the advancement direction V. The length L of the interaction region 18 in the advancement direction V is determined by the evaluation device 30 by way of a comparison of the spatially dependent intensity I within the image B with an intensity threshold value. By way of example, the intensity threshold value during the length measurement can be calculated in the form of a quotient of a mean intensity of a process light region of interest (ROI) B_{ROI} and a weighting factor. In the example shown, the process light region of interest B_{ROI} is a rectangular partial region of the image B of the region 28 of the workpiece 8 to be monitored. The manifestation of the process light region of interest B_{ROI} reaches—when the image B is recorded through a machining nozzle 16—from the cutting front 29 to the nozzle edge 16a of a nozzle opening 16b of the machining nozzle 16 in the advancement direction V. Transversely to the advancement direction V, the process light region of interest extends over the entire width of the interaction region 18.

A characteristic can be formed from the length L of the interaction region 18 in the advancement direction V, and this characteristic is compared to a threshold S which defines an incomplete cutting action threshold. For simplification, the assumption is made hereinbelow that the length L of the interaction region 18 itself forms the characteristic. If the characteristic, the length L of the interaction region 18 in the example shown, is smaller than the threshold value S, as is the case in FIG. 3A, then the evaluation device 30 does not identify an incomplete cutting action. The threshold value S, in the case of which an incomplete cutting action is usually not yet present, may be determined experimentally prior to the cutting process. It is also possible for the threshold value S to be not an absolute value but a percentage change of a current/defined work point of the characteristic. In this case, the characteristic determined on the basis of the image is related to a currently specified characteristic. To this end, it is for example possible to form a quotient of the characteristic (in this case: L) determined on the basis of the image to the characteristic at the work point. The quotient is then compared to the threshold value.

The characteristic or the length L of the interaction region 18 being greater than the threshold value S is not sufficient for the identification by the evaluation unit 30 of an incomplete cutting action since an incomplete cutting action may be present in this case but the threshold value S being exceeded may also be caused by other disruptions to the cutting process, as will be explained hereinafter on the basis of FIG. 3B and FIG. 3C.

FIG. 3B shows the image of the interaction region 18 when an incomplete cutting action is present, and an intensity profile I(Y) along the advancement direction V, corresponding to the Y-direction in the example shown, and the gradient dI/dY of the intensity profile I(Y). As is evident from FIG. 3B, the interaction region 18 has a significantly greater length L than in the case of the good cut shown in FIG. 3A, which is to say the threshold value S of the length L of interaction region 18 is exceeded. However, the threshold value S of the length L of the interaction region 18 is also exceeded if a supporting bar 7 is traversed during the cutting process, as illustrated in FIG. 3C on the basis of a corresponding image B of the interaction region 18. Therefore, the characteristic in the form of the length L of the interaction region 18 on its own does not allow a distinction to be made between a real incomplete cutting action, as depicted in FIG. 3B, and a pseudo-incomplete cutting action, as depicted in FIG. 3C.

However, such a distinction can be made on the basis of the intensity profile I(Y) in the advancement direction V within the interaction region 18 or on the basis of the gradient dI/dY of the intensity profile I(Y) in the advancement direction Y, as depicted at the bottom of FIG. 3B and FIG. 3C. There is no local intensity drop ΔI or no discontinuity within the interaction region 18 in the case of the intensity profile I(Y) shown in FIG. 3B, which is to say there is no local intensity minimum I_{MIN} as is the case in FIG. 3C. As is evident from FIG. 3C, the local intensity minimum I_{MIN} or the intensity drop ΔI occurs at a point in the advancement direction V at which approximately the end of the interaction region 18 would be expected in the case of the interaction region 18 for a non-disrupted cutting process, shown in FIG. 3A. This fact facilitates the identification in real time of the occurrence of the intensity drop ΔI or the discontinuity in the intensity profile I(Y) by means of suitable image evaluation algorithms.

In the example shown, the presence of the local intensity drop ΔI is detected by the evaluation device 30 if both a local minimum (dI/dY)_{MIN} of the gradient dI/dY and a local maximum (dI/dY)_{MAX} of the gradient dI/dY of the intensity profile I(Y) exceed an (absolute) threshold value (dI/dY)_{S} depicted using dashed lines in FIGS. 3B, 3C. The threshold value (dI/dY)_{S} can be determined experimentally or defined on the basis of the current work point. A detection of the presence or the lack of the local intensity drop ΔI by way of an evaluation of the gradient dI/dY was found to be advantageous.

Alternatively, the occurrence of the intensity drop ΔI may be detected by the evaluation device 30 if the value of the intensity minimum I_{MIN} drops below a specified percentage component, for example less than 80%, of the maximum intensity I_{MAX} of the intensity profile I(Y) in the interaction region 30, which is to say when the local intensity drop ΔI is at least 20% of the maximum intensity I_{MAX}. It is also possible to combine the criterion for the presence of the intensity drop ΔI on the basis of the gradient dI/dY described hereinabove with the criterion described here. By way of example, the criterion described here can serve to check the plausibility of the criterion described hereinabove.

If the lack of the local intensity drop ΔI within the interaction region 18 is detected over a given (short) path length, for example of the order of approx. 10 mm, by the evaluation device 30, which might be for example a computer or suitable hardware and/or software, for example in the form of an ASIC, FPGA, etc., and if the threshold value S of the characteristic or the length L of the interaction region 18 is exceeded, then the evaluation device 30 identifies an incomplete cutting action.

As is evident from FIG. 2, the evaluation device 30 is signal-connected to an open-loop or closed-loop control device 31, which controls the laser cutting process. If an incomplete cutting action identified by the evaluation device 30 is present, then the open-loop/closed-loop control device 31 can suitably adjust the cutting parameters of the laser cutting process in order to counteract a continuation of the incomplete cutting action during the further implementation of the laser cutting process. However, alternatively, it is also possible for the open-loop or closed-loop control device 31 to terminate the cutting process when the incomplete cutting action is identified, or optionally restart the cutting process in order to machine the affected point again and completely cut through the region of the workpiece 8 affected by the incomplete cutting action, or it is also possible for the open-loop/closed-loop control device 31 to output information about the incomplete cutting action to a user.

In addition to the process-related disruptions such as an incomplete cutting action, it is also possible to identify position-dependent disruptions 37 and/or angle-dependent disruptions 38 to the cutting process (cf. FIG. 1) on the basis of the features of the interaction region 18. By way of example, in the case of a detection (in particular in the case of multiple detections) of a local intensity drop ΔI at one (or at one and the same) machining position B_{X,Y} of the workpiece support 5, it is possible to assign a position-dependent disruption 37 of the machining process in the form of a supporting bar 7 or, optionally, a local contamination of the supporting bar 7 (hot spot) to this machining position B_{X,Y}. The respective machining position B_{X,Y} can be assigned to a respective recorded image B on the basis of the assigned machine coordinates X, Y, Z of the movement device 12 during the recording of the image B.

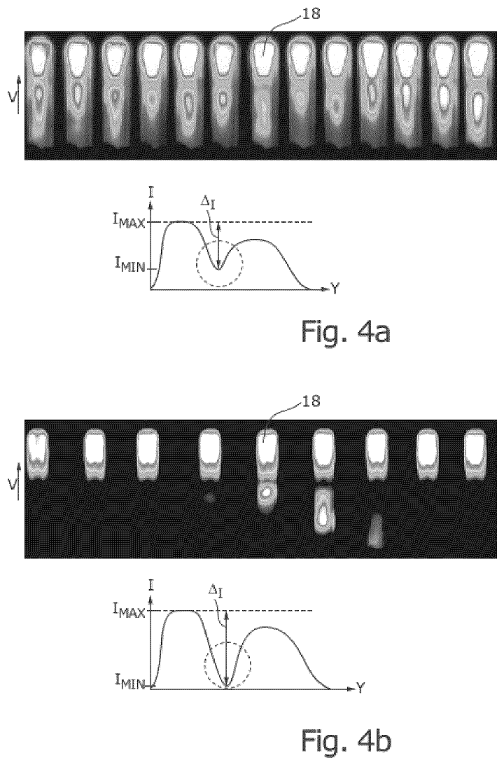

As is evident on the basis of FIGS. 4A and 4B, the degree or the strength of the position-dependent disruption can be determined on the basis of the absolute value or size of the local intensity drop ΔI along the intensity profile I(Y) and/on the basis of the gradient dI/dY of the intensity profile I(Y): In the case of the example shown in FIG. 4A, the local intensity drop ΔI is approximately 65% of the maximum intensity value I_{MAX} of the intensity profile I(Y), while the local intensity drop ΔI is more than approximately 95% of the maximum intensity value I_{MAX} in the case of the example shown in FIG. 4B. An (optionally only locally) very contaminated support bar 7 is present in the example shown in FIG. 4A, while a practically uncontaminated support bar 7 is present in the example shown in FIG. 4B. Consequently, the degree of contamination of the support bar 7 can be deduced by the evaluation unit 30 on the basis of the size of the intensity drop ΔI.

To determine the strength of the position-dependent disruption, it is also possible to evaluate the gradient dI/dY of the intensity profile I(Y) (not depicted in FIGS. 4A, 4B), as described in the context of FIGS. 3B, 3C. In this case, the degree or strength of the disruption can be determined for example on the basis of the absolute value of a local minimum (dI/dY)_{MIN} of the gradient dI/dY or absolute value of a local maximum (dI/dY)_{MAX} of the gradient dI/dY of the intensity profile I(Y).

In principle, the intensity profile I(Y) shown in FIG. 4A may also be caused by a different type of disruption, for example by a double metal sheet. However, if the intensity drop ΔI is detected multiple times at one and the same machining position B_{X,Y}, then the assumption can be made that a support bar 7 is located at this machining position B_{X,Y}.

Therefore, the type of disruption to the machining process, for example the presence of a support bar or a double sheet metal, can be deduced on the basis of the evaluation of a plurality of temporally successive images B of the interaction region 18, as are illustrated in FIGS. 4A, 4B by way of example.

The method described hereinabove for identifying disruptions during a machining process is not restricted to a cutting process but may also be used in other machining processes, for example in welding processes. Additionally, a different type of machining beam, for example a plasma beam, can be used in place of laser beam 6. In this case, a plasma head is used as a machining tool 4 instead of a laser machining head.

1. A method for identifying at least one disruption during a machining process, the method comprising:
machining a workpiece while moving a machining tool and the workpiece relative to one another;
recording an image of a region on the workpiece to be monitored, the region to be monitored being an interaction region of the machining tool with the workpiece;
evaluating the image of the region to be monitored for identifying the at least one disruption during the machining process by detecting a presence or a lack of a local intensity drop in an intensity profile within the interaction region along an advancement direction of the machining process.

2. The method according to claim 1, wherein the machining process is a cutting process, the machining step is a cutting step, and the machining tool is a laser machining head.

3. The method according to claim 1, which comprises identifying an incomplete cutting action as a disruption during the cutting of the workpiece only when a lack of the local intensity drop is detected within the interaction region.

4. The method according to claim 1, wherein, for identifying the disruption, detecting at least one geometric feature of the interaction region during the evaluation of the image.

5. The method according to claim 4, wherein the at least one geometric feature of the interaction region is a length of the interaction region in the advancement direction.

6. The method according to claim 5, which comprises identifying an incomplete cutting action during the cutting if a characteristic that depends on the length of the interaction region in the advancement direction exceeds a threshold value and if the lack of the local intensity drop is detected within the interaction region.

7. The method according to claim 1, which comprises assigning a detection of the local intensity drop at a machining position to a position-dependent disruption of the machining process.

8. The method according to claim 7, which comprises assigning a repeated detection of the local intensity drop at the machining position to a presence of a supporting bar at the machining position.

9. The method according to claim 8, which comprises determining a degree of the position-dependent disruption on a basis of the intensity profile).

10. The method according to claim 8, which comprises determining a degree of a contamination of the supporting bar on a basis of a gradient of the intensity profile).

11. The method according to claim 1, which comprises deducing a type of disruption of the machining process from an evaluation of a plurality of temporally successive images of the interaction region.

12. A machining apparatus, comprising:
a machining tool for machining a workpiece;
a movement device for moving the machining tool and the workpiece relative to one another;
an image capturing device for recording an image of a region on the workpiece to be monitored, the region to be monitored including an interaction region of the machining tool with the workpiece; and
an evaluation device configured to identify at least one disruption of the machining process based on an evaluation of the image of the region to be monitored, said evaluation device being configured to identify the disruption by detecting, during the evaluation of the image, a presence or a lack of a local intensity drop in an intensity profile within the interaction region in an advancement direction of the machining process.

13. The method according to claim 12, wherein said machining tool is a laser machining head and the machining process is a cutting process.

14. The machining apparatus as claimed in claim 13, wherein said evaluation device is configured to identify an incomplete cutting action only as a disruption during a cutting of the workpiece in the case where the lack of the local intensity drop is detected within the interaction region.

15. The machining apparatus as claimed in claim 12, wherein, for the purpose of identifying the disruption, said evaluation unit is configured to detect, during the evaluation of the image, at least one geometric feature of the interaction region.

16. The machining apparatus as claimed in claim 15, wherein the at least one geometric feature is a length of the interaction region in the advancement direction.

17. The machining apparatus according to claim 16, wherein said evaluation unit is configured to identify an incomplete cutting action during the machining if a characteristic that depends on the length of the interaction region exceeds a threshold value and if the lack of the local intensity drop is detected within the interaction region.

18. The machining apparatus according to claim 12, wherein said evaluation device is configured to assign a detection of the local intensity drop at a machining position to a position-dependent disruption of the machining process at the machining position.

19. The machining apparatus according to claim 12, wherein said evaluation device is configured to determine a degree of the position-dependent disruption on the basis of the intensity profile).

20. The machining apparatus according to claim 12, wherein said evaluation device is configured to deduce a type of disruption of the machining process on a basis of the evaluation of a plurality of temporally successive images of the interaction region.
